(19) United States
(12) Patent Application Publication
(10) Pub. No.: US 2025/0272191 A1
(43) Pub. Date: Aug. 28, 2025

(54) MEMORY DEVICE USING WEAR LEVELING WITH SHARED SCRUB LOOP

(71) Applicant: Micron Technology, Inc., Boise, ID (US)

(72) Inventors: Bryan David Kerstetter, Kuna, ID (US); John David Porter, Boise, ID (US); Donald M. Morgan, Meridian, ID (US); Alan J. Wilson, Boise, ID (US)

(21) Appl. No.: 18/783,315

(22) Filed: Jul. 24, 2024

Related U.S. Application Data
(60) Provisional application No. 63/556,652, filed on Feb. 22, 2024.

(51) Int. Cl. G06F 11/10

(52) U.S. Cl. CPC G06F 11/106; G06F 11/1044

(57) ABSTRACT

Systems, methods, and apparatus for memory management operations in a memory device. In one approach, each of multiple banks in a memory array includes a scrub holding register and a source holding register. Data is scrubbed in the background by moving data from a source page to the scrub holding register. Data in the scrub holding register is scrubbed by error correction circuitry shared by the multiple banks. Any writes that occur to the address of the source page during the scrubbing are made to the source holding register. Status data is recorded regarding any such writes that occur. After scrubbing is complete, the scrubbed data is moved to a target page by combining data from the scrub and source holding registers as guided by the status data.

### RELATED APPLICATIONS

The present application claims priority to Prov. U.S. Pat. App. Ser. No. 63/556,652 filed Feb. 22, 2024, the entire disclosure of which application is hereby incorporated herein by reference.

### FIELD OF THE TECHNOLOGY

At least some embodiments disclosed herein relate to memory devices in general, and more particularly, but not limited to memory devices that perform memory management operations (e.g., wear leveling).

### BACKGROUND

Memory devices can include semiconductor circuits that provide electronic storage of data for a host system (e.g., a server or other computing device). Memory devices may be volatile or non-volatile. Volatile memory requires power to maintain data, and includes devices such as random-access memory (RAM), static random-access memory (SRAM), dynamic random-access memory (DRAM), or synchronous dynamic random-access memory (SDRAM), among others. Non-volatile memory can retain stored data when not powered, and includes devices such as flash memory, read-only memory (ROM), electrically erasable programmable ROM (EEPROM), erasable programmable ROM (EPROM), resistance variable memory, such as phase change random access memory (PCRAM), resistive random-access memory (RRAM), or magnetoresistive random access memory (MRAM), among others.

Host systems (e.g., a host device) can include a host processor, a first amount of host memory (e.g., main memory, often volatile memory, such as DRAM) to support the host processor, and one or more storage systems (e.g., non-volatile memory, such as flash memory) that provide additional storage to retain data in addition to or separate from the main memory.

A storage system, such as a solid-state drive (SSD), can include a memory controller and one or more memory devices, including a number of (e.g., multiple) dies or logical units (LUNs). In certain examples, each die can include a number of memory arrays and peripheral circuitry thereon, such as die logic or a die processor. The memory controller can include interface circuitry configured to communicate with a host device (e.g., the host processor or interface circuitry) through a communication interface (e.g., a bidirectional parallel or serial communication interface). The memory controller can, for example, receive commands or operations from the host system in association with memory operations or instructions, such as read or write operations to transfer data (e.g., user data and associated integrity data, such as error data or address data, etc.) between the memory devices and the host device, erase operations to erase data from the memory devices, perform drive management operations (e.g., data migration, garbage collection, block retirement), etc.

Many memory devices, particularly non-volatile memory devices, such as NAND flash devices, etc., frequently relocate data or otherwise manage data in the memory devices (e.g., garbage collection, wear leveling, drive management, etc.). NAND flash is a type of flash memory constructed using NAND logic gates. Alternatively, NOR flash is a type of flash memory constructed using NOR logic gates.

Volatile memory devices such as DRAM typically refresh stored data. For example, refresh is activating and then precharging a row. At activation time the data in the cells are sensed (implicitly read), and at precharge time the data is written back to the cells (implicitly written).

Storage devices can have controllers that receive data access requests from host computers and perform programmed computing tasks to implement the requests in ways that may be specific to the media and structure configured in the storage devices. In one example, a flash memory controller manages data stored in flash memory and communicates with a computing device. In some cases, flash memory controllers are used in solid-state drives for use in mobile devices, or in SD cards or similar media for use in digital cameras.

Firmware can be used to operate a flash memory controller for a particular storage device. In one example, when a computer system or device reads data from or writes data to a flash memory device, it communicates with the flash memory controller.

Although current memory technologies provide for various functionality and benefits, situations often arise that may potentially cause degradation to the memory devices, potential data loss, damage to memory cells of the memory devices, among potential harmful effects to the memory devices. For example, certain memory cells of a memory array may be the target of a disproportionate number of read operations, write operations, other operations, or a combination thereof, when compared to other memory cells of the memory array. In such instances, such memory cells may wear out faster than other less-frequently-used memory cells.

Various techniques exist for extending the life of memory cells and balancing memory usage in memory devices. For example, wear leveling is a memory management technique that can extend the useful life of the memory cells of a device by effectively spreading memory usage across the various sections of the memory array so that the sections experience comparable memory usage. Wear leveling, for example, may involve transferring data from source memory rows located in a section of a memory array to target rows that may be located in another section of the memory array and then mapping the addresses of the source memory rows to addresses corresponding to the target memory rows. Memory management technologies may be enhanced to reduce the amount of memory resources utilized to conduct memory management, reduce errors in data and error correction bits, and further extend the life of memory.

### BRIEF DESCRIPTION OF THE DRAWINGS

The embodiments are illustrated by way of example and not limitation in the figures of the accompanying drawings in which like references indicate similar elements.

FIG. 1 shows a memory device having error correction circuitry coupled to one or more memory arrays using a scrub loop, in accordance with some embodiments.

FIG. 2 shows circuitry to correct errors in pages stored in a memory array, in accordance with some embodiments.

FIG. 3 shows sense amplifier latches to hold data associated with memory cells of a memory array, in accordance with some embodiments.

FIG. 4 shows a bank of a memory array having a source holding register and a scrub holding register, in accordance with some embodiments.

FIG. 5 shows the bank of FIG. 4 during scrub operations using an ECC engine, in accordance with some embodiments.

FIG. 6 shows the transfer of scrubbed data to a target page in the bank of FIG. 4, in accordance with some embodiments.

FIG. 7 shows a non-limiting example of the transfer of scrubbed data to a target page using update latches, in accordance with some embodiments.

FIG. 8 shows a data path for read and write operations for a host device and a scrub loop shared by multiple banks for servicing scrubbing operations, in accordance with some embodiments.

FIG. 9 shows banks of a memory management group coupled to a wear leveling ECC engine, in accordance with some embodiments.

FIG. 10 shows a process for scrubbing multiple banks in a memory management group, in accordance with some embodiments.

FIG. 11 shows error correction circuitry for scrubbing code words from a bank of a memory array, in accordance with some embodiments.

FIG. 12 shows a method for scrubbing data in a memory array using temporary storage, in accordance with some embodiments.

### DETAILED DESCRIPTION

The following disclosure describes various embodiments for performing memory management operations (e.g., error correction to scrub stored data) using a scrub loop associated with one or more memory arrays. At least some embodiments herein relate to a non-volatile memory device that includes a scrub loop used for wear leveling. In some embodiments, a volatile memory device uses a scrub loop for scrubbing data (e.g., error check and scrub in a DRAM). These memory devices may, for example, store data used by a host device (e.g., a computing device of an autonomous vehicle, or another computing device that accesses data stored in the memory device). In one example, the memory device is a solid-state drive mounted in an electric vehicle.

Storage elements in a memory device may degrade and fail with use. In some cases, a memory device may implement an algebraic wear leveling scheme in order to mitigate wear and an on-die ECC scheme. This wear leveling scheme will adjust logical-to-physical address mapping for a wear leveling pool as part of performing the wear leveling. Each wear leveling pool requires specific circuitry to facilitate wear leveling movements and logical to physical address translation. Historically, the scope of a wear leveling pool may be an individual bank.

In one example, an algebraic-based wear leveling scheme uses an additional row in a memory array to allow wear leveling movements. The wear leveling movements consist of moving source data (e.g., pointed to by a source pointer) to a target row (e.g., pointed to by a target pointer). A physical address is determined by adding a present or next offset to a logical address. Given a logical address, and assuming the target pointer and source pointer are maintained properly, then an algorithm permits determining the physical address. Source data at a source address is moved to a target address. The target pointer and source pointer are updated after each wear leveling movement. The offset pointer is regularly updated according to the movements.

Wear leveling (sometimes indicated by “WrL”) movements may be triggered by an activity-based (e.g., a refresh management (RFM) command for DRAM) or periodic memory management (MM) command (e.g., based on a repeating time interval). Each memory management command causes a portion of a wear leveling movement to occur for each bank in a memory management group. Each memory management group can contain one or more banks.

In one example, a memory device is a flash memory in an SSD, or a device using another memory technology having cells that sustain sufficient wear to require wear leveling to ensure sufficient lifetime. A wear leveling pool includes addresses that are cycled through wear leveling movements so that any given logical address over time could be associated with any physical address in the pool. An activity-based refresh management command (RFM) for DRAM is used to trigger wear leveling movements. In one example, the wear leveling movement is broken up into two portions using a holding register. Data goes through an ECC scrub when being moved from a source address to the holding register. Data is then moved one code word at a time from the holding register to a target address.

Before source data is written to a target row during wear leveling, an ECC scrub is performed on the source data. Scrubbing correctable errors during wear leveling prevents the accumulation of correctable errors that could aggregate into an uncorrectable error. Thus, scrubbing correctable errors during wear leveling reduces the likelihood of experiencing uncorrectable errors.

Historically, each bank contains its own separate ECC engine. However, certain layout area constraints may result in the above approach that uses per-bank ECC engines to be unfeasible. There is a need for an approach to solve this technical problem and enable multiple banks to use one or more shared ECC engines (e.g., a single ECC engine located at an edge of a bank group) to scrub source data during wear leveling movements without significant impact to existing memory management specifications.

In one example of the technical problem above, each bank in a memory device has its own wear-leveling engine, and multiple banks can be maintained in parallel. Wear leveling occurs in parallel for all of the banks. However, in some cases due to layout or other constraints, it is no longer feasible that each bank have its own ECC engine. If an ECC engine is shared by banks in the same memory management group, then those banks cannot be managed in parallel. If an ECC engine is shared by banks in a different memory management group but in the same bank group, there may be scheduling conflicts when both wear leveling scrub and data access need to use the ECC engine at the same time. As a result, a controller cannot access any of the data in any of the banks (e.g., within a bank group) while the scrub process for wear leveling is occurring for one of the other banks in the bank group.

Various embodiments of the present disclosure provide a technological solution to one or more of the above technical problems. In one embodiment, each group of banks in a memory device contains its own standard ECC engine (e.g., located at the edge of the bank group). This ECC engine operates during standard read and write commands using a standard data path. An additional wear leveling ECC engine is used in a separate channel to facilitate ECC scrubbing during wear leveling movements. A serial transmission loop is used to allow background communication between the banks of the memory management group and the wear leveling ECC engine. Advantages include that the standard data path is not disturbed. The standard ECC engine(s) service reads and writes, and separate ECC engine(s) service ECC scrub or other memory management operations (e.g., scrubbing during wear leveling).

In one embodiment, a memory device includes a first register (e.g., a scrub holding register) and a second register (e.g., a source holding register). A controller moves data from a source page to the first and second registers, updates the data in the first register based on error correction of the data, and updates the data in the second register based on any write that may occur (during the error correction) to the source page.

The memory device further includes error correction circuitry (e.g., wear-leveling ECC engine) to perform the error correction. The write may occur during the error correction. After the error correction, the controller moves data from the source page to a target page based on a combination of data from the first and second registers. In one embodiment, a plurality of latches are used to indicate writes that occur to the source page. The combination of data is based on the indications stored by the latches.

In one embodiment, a memory device includes at least one memory array, and at least one controller. The controller performs read and write operations for first data in the memory array using error correction, and scrubs second data in the memory array during the read and write operations. The read and write operations use first error correction circuitry (e.g., main ECC engine), and the scrubbing uses second error correction circuitry (e.g., separate ECC engine connected to memory banks using a scrub loop). In one embodiment, the memory array is configured in a volatile memory device (e.g., DRAM), and the second data is scrubbed as part of an error check and scrub (ECS) operation.

In various embodiments, the need for the source holding register depends on whether or not data is being moved to a different row. For example, only one holding register (e.g., scrub holding register) is needed if data is not moved to a different row. For example, if data is being moved to a different row, then a second register (e.g., source holding register) is needed.

In one embodiment, a DRAM device performs an error check and scrub (ECS) operation. A scrub loop is utilized to facilitate scrubs during ECS operations. This requires using one holding register (scrub holding register). A number of update latches used (as described below) is dependent upon the number of code words transferred to/from the holding register. The scrubbed data is written to the same array location (e.g., array location pointed to by ECS counter).

In one embodiment, an emerging memory device performs wear leveling. A scrub loop is utilized to facilitate scrubs during wear leveling. This requires two holding registers (scrub holding register and source holding register). The number of update latches is dependent upon the number of code words transferred to/from the holding registers. The scrubbed data is written to a new array location (e.g., target row).

In one embodiment, a controller scrubs data stored in a source page of a memory array, and performs an operation to write data to the source page while the scrubbing is still being performed in the background. The data being written is stored at a temporary storage location (e.g., register or buffer) during the scrubbing (e.g., source holding register). The data is written from the temporary storage location to a target page after the data is scrubbed (e.g., scrubbed data is stored in the scrub holding register, and the data is written using a combination of code words from the scrub holding register and the source holding register).

In one embodiment for a memory device, each bank group contains its own standard ECC engine located at the physical layout edge of the bank group. This standard ECC engine operates during standard read and write commands (e.g., received from a host device). Additional shared wear leveling ECC engine(s) are added in a channel to facilitate ECC scrub during wear leveling movements. The channel is separate from a data path used for handling the standard read and write commands. A serial transmission loop is used to allow background communication between the banks and the wear leveling ECC engine.

Each bank includes a holding register pair of a source holding register and a scrub holding register. A first memory management command is used to initiate scrubbing (e.g., for a code word), and a second memory management command is used to conclude this scrubbing.

The source holding register holds data from a source row that is being scrubbed in place of the source row in between the first and second memory management commands for reads and writes. For any writes that occur, the standard ECC engine generates parity for incoming data. Data and parity are placed in a column of the source holding register. For reads, the standard ECC engine corrects the read data.

The scrub holding register stores contents of the source row for transmission to the wear leveling ECC engine. The scrub holding register receives and stores scrubbed source row data from the wear leveling ECC engine.

An update latch is used for each column (e.g., code word or data plus parity). The update latches are used to track which of the columns have been written to since receiving the first memory management command. In other words, the latches track which columns (e.g., code words) have been written to while the scrubbing is being performed by the wear leveling ECC engine.

When data scrubbing is complete, the scrubbed data is moved to a target row. The data moved to the target row is formed by combining data from each of the registers in the holding register pair according to the state of the update latches. In this way, the data moved to the target row will reflect any changes that occurred due to a write that was performed during the background scrubbing.

Memory management to memory management command spacing (e.g., tMM2MM) is made greater than an elapsed time between all banks in a memory management group (e.g., MM Bank) sending source data and then all banks in the group (e.g., MM Bank) receiving scrubbed source data. The serial transmission loop can be a scrub loop consisting of a bi-directional bus from the banks to/from the wear leveling ECC engine, or uni-directional buses from the banks to/from wear leveling ECC engine.

Various advantages can be provided by at least some embodiments described herein. For example, die area is reduced in the case of a non-COA (CMOS Over Array) or non-CUA (CMOS Under Array) memory device. For example, a wear leveling solution is provided in the case that a per-bank ECC engine cannot be implemented entirely under or over the array. For example, minimal alterations are needed to an established memory management specification.

In one embodiment, a code word ECC engine is used to detect and correct errors on a given code word. The code word consists of data and parity to be processed by the code word ECC engine. A scrub by the code word ECC engine is triggered by an activity-based memory management operation.

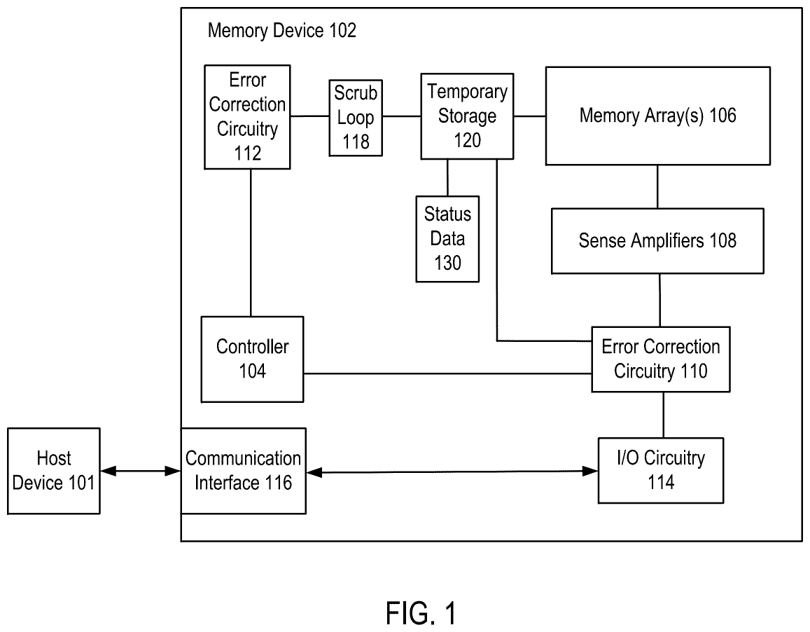

FIG. 1 shows a memory device 102 having error correction circuitry 112 coupled to one or more memory arrays 106 using a scrub loop 118, in accordance with some embodiments. In one embodiment, error correction circuitry 112 services memory management operations performed on data stored in memory array(s) 106. Portions of data from memory array 106 are copied to temporary storage 120 during servicing.

In one example, temporary storage 120 includes source and scrub holding registers as described above. In one example, error correction circuitry 112 is a wear leveling ECC engine. In one example, scrub loop 118 is a data path that is separate from a data path used for standard read and write operations for host device 101.

While data is being serviced by the ECC engine, the data is stored in temporary storage 120. In one example, the data has been copied from a source page of memory array 106. In some cases, write operations will be performed by controller 104 and/or host device 101 to the address location of the source page that is being serviced. Indications are stored regarding any such write operations that occur. These indications are stored as status data 130.

In one example, status data 130 is stored by a plurality of update latches. A state of each latch is used to indicate whether a column or code word of the page has been written to while being serviced by error correction circuitry 112. For example, controller 104 uses status data 130 when copying scrubbed data to a target page in memory array 106.

Error correction circuitry 110 services read and write operations on a separate data path from the scrub loop 118. For example, the read or write operations are performed in response to commands or other signals received from host device 101.

Controller 104 accesses portions of memory array(s) 106 in response to commands received from host device 101 via communication interface 116. Sense amplifiers 108 sense data stored in memory cells of memory arrays 106. Controller 104 accesses the stored data by activating one or more rows of memory arrays 106. In one example, the activated rows correspond to a page of stored data.

When a row of memory array 106 is activated, data can be read from the row as part of a read or other operation (e.g., wear leveling). Error correction circuitry 110 is used to detect and correct any errors identified in the accessed data on the row for a read requested by host device 101. Corrected read data is provided for output on communication interface 116 by I/O circuitry 114. In case read data is requested from the source row, the data from the source holding register within temporary storage 120 is supplied to the error correction circuitry 110.

In one embodiment, communication interface (I/F) 116 is a bi-directional parallel or serial communication interface. The host device 101 can include a host processor (e.g., a host central processing unit (CPU) or other processor or processing circuitry, such as a memory management unit (MMU), interface circuitry, etc.).

In one embodiment, memory arrays 106 can be configured in a number of non-volatile memory devices (e.g., dies or LUNs), such as one or more stacked flash memory devices each including non-volatile memory (NVM) having one or more groups of non-volatile memory cells and a local device controller or other periphery circuitry thereon (e.g., device logic, etc.), and controlled by controller 104 over an internal storage-system communication interface (e.g., an Open NAND Flash Interface (ONFI) bus, etc.) separate from the communication interface 116.

In one embodiment, each memory cell in a NOR, NAND, 3D Cross Point, MRAM, or one or more other architecture semiconductor memory array 106 can be programmed individually or collectively to one or a number of programmed states. A single-level cell (SLC) can represent one bit of data per cell in one of two programmed states (e.g., 1 or 0). A multi-level cell (MLC) can represent two or more bits of data per cell in a number of programmed states (e.g., 2ⁿ, where n is the number of bits of data). In certain examples, MLC can refer to a memory cell that can store two bits of data in one of 4 programmed states. A triple-level cell (TLC) can represent three bits of data per cell in one of 8 programmed states. A quad-level cell (QLC) can represent four bits of data per cell in one of 16 programmed states. In other examples, MLC can refer to any memory cell that can store more than one bit of data per cell, including TLC and QLC, etc.

The controller 104 can receive instructions from the host device 101, and can transfer data to (e.g., write or erase) or from (e.g., read) one or more of the memory cells of the memory arrays 106. The controller 104 can include, among other things, circuitry or firmware, such as a number of components or integrated circuits. For example, the controller 104 can include one or more memory control units, circuits, or components configured to control access across the memory array and to provide a translation layer between the host device 101 and a storage system, such as a memory manager, one or more memory management tables, etc.

In one embodiment, controller 104 can include circuitry or firmware, such as a number of components or integrated circuits associated with various memory management functions, including, among other functions, wear leveling, error detection or correction, bank or block retirement, or one or more other memory management functions.

In one embodiment, controller 104 can include a set of management tables configured to maintain various information associated with one or more components of memory device 102 (e.g., various information associated with a memory array or one or more memory cells coupled to controller 104). For example, the management tables can include information regarding bank or block age, block erase count, error history, or one or more error counts (e.g., a write operation error count, a read bit error count, a read operation error count, an erase error count, etc.) for one or more banks or blocks of memory cells coupled to the controller 104. In certain examples, if the number of detected errors for one or more of the error counts is above a threshold, the bit error can be referred to as an uncorrectable bit error. The management tables can maintain a count of correctable or uncorrectable bit errors, among other things.

In one embodiment, memory device 102 can include one or more three-dimensional (e.g., 3D NAND) architecture semiconductor memory arrays 106. The memory arrays 106 can include a number of memory cells arranged in, for example, banks, a number of devices, planes, blocks, physical pages, super blocks, or super pages. As one example, a TLC memory device can include 18,592 bytes (B) of data per page, 1536 pages per block, 548 blocks per plane, and 4 planes per device.

In one embodiment, data can be written to or read from the memory device 102 in pages. However, one or more memory operations (e.g., read, write, erase, etc.) can be performed on larger or smaller groups of memory cells, as desired. For example, a partial update of tagged data from an offload unit can be collected during data migration or garbage collection to ensure it was re-written efficiently.

In one example, a page of data includes a number of bytes of user data (e.g., a data payload) and its corresponding metadata. As an example, a page of data may include 4 KB of user data as well as a number of bytes (e.g., 32B, 54B, 224B, etc.) of auxiliary or metadata corresponding to the user data, such as integrity data (e.g., error detecting or correcting code data), address data (e.g., logical address data, etc.), or other metadata associated with the user data. Different types of memory cells or memory arrays can provide for different page sizes, or may require different amounts of metadata associated therewith.

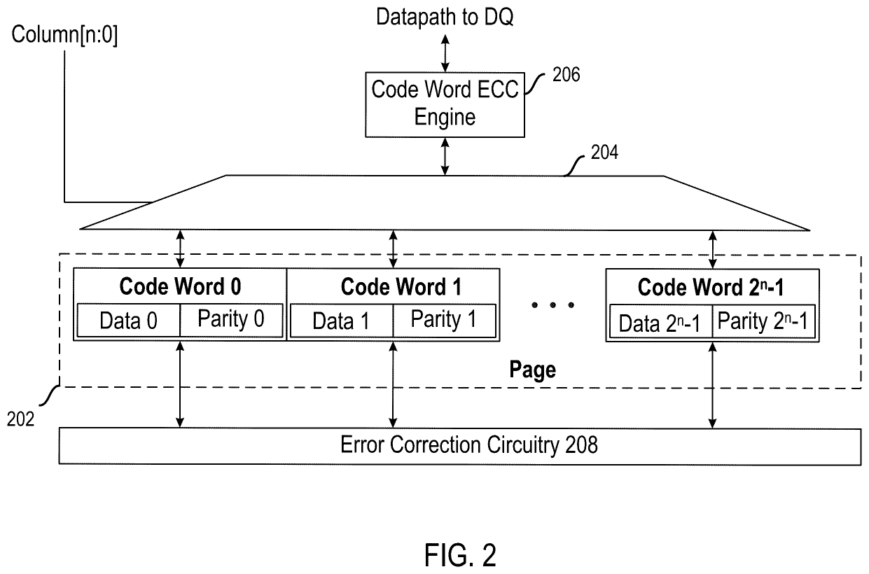

FIG. 2 shows circuitry to correct errors in pages stored in a memory array, in accordance with some embodiments. Code word ECC engine 206 is an example of error correction circuitry 110 and services data for a standard read and write data path of a memory device. Error correction circuitry 208 services memory management operations for data stored in page 202. Error correction circuitry 208 is an example of error correction circuitry 112 and is connected to a bank of a memory bank group. Error correction circuitry 208 receives code words from page 202 using a scrub loop (e.g., 118).

In one example, the page is accessed by activating a row in memory array 106. The error in the accessed page is detected using code word ECC engine 206 or error correction circuitry 208. In one embodiment, one or more parity bits are used to check for errors in the page. Other error detection schemes can be used in other embodiments.

In one example, page 202 contains multiple code words 0, 1, . . . 2ⁿ−1. In one embodiment, data stored in the code words of page 202 includes both user data and parity data stored for each code word.

Each page 202 in the memory array has multiple columns [n:0]. Data being read from or written to page 202 is addressed by a row address and a column address. The row address corresponds to a word line that is activated to access data stored in page 202. The column address is used by column decoder 204 to select a column for memory cells containing the data to be accessed.

During a read operation, data read from page 202 is processed by code word ECC engine 206 to detect and correct errors. Corrected data is, for example, communicated to a host device via a data path to input/output pins (e.g., DQ pins).

In one embodiment, each code word of page 202 includes user data (e.g., Data 0) and a parity (e.g., Parity 0) previously calculated for that data. In one example, the parity is an error correction code providing a capability to correct one or more bits of the code word. The parity stored for each code word can be computed by ECC engine 206 when the code word is stored. ECC engine 206 can use the parity stored for each code word to detect and correct one or more bit errors of the code word when the code word is being read.

In one example, when an activate command is issued, page 202 is sensed, and the page's data is stored in sense amplifier latches.

In one example, a memory management operation is allocated to scrub the page 202. The scrub uses error correction circuitry 208 where each code word is scrubbed one at a time (e.g., the corrected data is written back into the scrub holding register one code word at a time). Data transfer from the DQ (input/output) pins of the memory device involves use of the code word ECC engine 206 and does not involve the error correction circuitry 208.

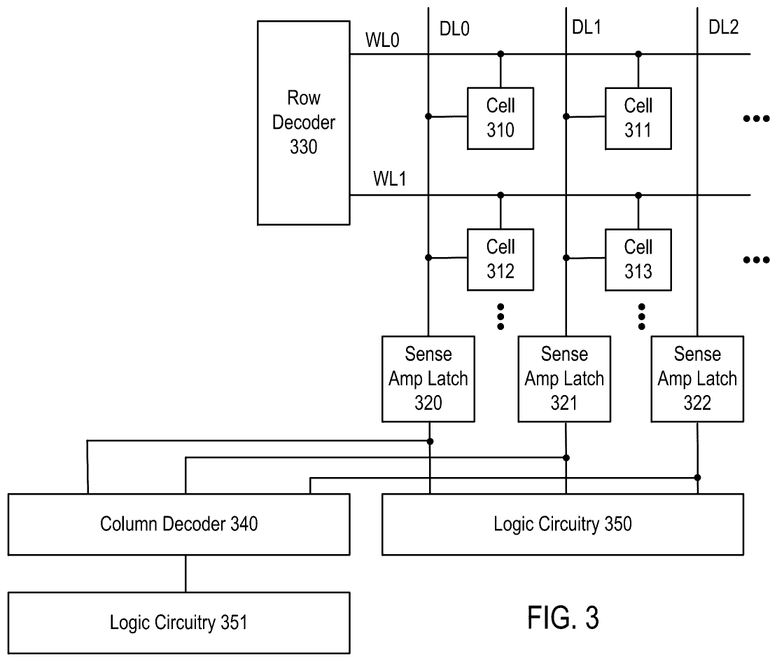

FIG. 3 shows sense amplifier latches 320, 321, 322 to hold data associated with memory cells 310, 311, 312, 313 of a memory array, in accordance with some embodiments. In one example, the memory cells are located in memory array 106. The memory cells can be of various memory types including volatile and/or non-volatile memory cells.

The memory cells are accessed using word lines (e.g., WL0) and digit lines (e.g., DL0) or bit lines. An individual memory cell is accessed by activating a word line selected by row decoder 330 and selecting a digit line or bit line selected by column decoder 340. When a word line is activated, data from each memory cell on a row resides in the corresponding sense amplifier latch for each digit line or bit line.

Data residing in the sense amplifier latches can be used as inputs to logic circuitry 350, 351 for various computations. These can include using parity or other metadata stored with the memory cells to detect and/or correct errors in the data retrieved from the memory cells. In one embodiment, logic circuitry 350 includes error correction circuitry 112. In one example, logic circuitry 350 is arbitrary logic that operates on data at the page level.

Logic circuitry 351 is coupled to column decoder 340. In one embodiment, logic circuitry includes error correction circuitry 110. In one example, logic circuitry 351 is arbitrary logic that operates on data at the column (e.g., code word) level (e.g., ECC engine 206).

In one embodiment, a memory device including a memory array has a plurality of memory cells 310, 311, 312, 313, etc., and one or more circuits or components to provide communication with, or perform one or more memory operations on, the memory array. A single memory array or additional memory arrays, dies, or LUNs can be used. The memory device can include row decoder 330, column decoder 340, sense amplifiers, a page buffer, a selector, an input/output (I/O) circuit, and a controller.

In some non-volatile memory devices (e.g., NAND flash), the memory cells of the memory array can be arranged in blocks. Each block can include sub-blocks. Each sub-block can include a number of physical pages, each page including a number of memory cells. In some examples, the memory cells can be arranged in a number of rows, columns, pages, sub-blocks, blocks, etc., and accessed using, for example, access lines, data lines, or one or more select gates, source lines, etc.

In volatile memory devices (e.g., DRAM) and some emerging non-volatile memory technologies, the memory cells of the memory array can be arranged in banks or other forms of partition. In one example, when an activate to a row address is issued, the row address may be addressed by addressing bits on the activate command using a bank address (to specify which bank within the memory device), and a row address (to specify which row within the specified bank). The word line associated with the row address is brought high.

A controller (e.g., controller 104) can control memory operations of the memory device according to one or more signals or instructions received on control lines (e.g., from host device 101) including, for example, one or more clock signals or control signals that indicate a desired operation (e.g., write, read, erase, etc.), or address signals (A0-AX) received on one or more address lines. One or more devices external to the memory device can control the values of the control signals on the control lines, or the address signals on the address line. Examples of devices external to the memory device can include, but are not limited to, a host, a memory controller, a processor, or one or more circuits or components.

The memory device can use access lines and data lines to transfer data to (e.g., write or erase) or from (e.g., read) one or more of the memory cells. The row decoder and the column decoder can receive and decode the address signals (A0-AX) from the address line, can determine which of the memory cells are to be accessed, and can provide signals to one or more of the access lines (e.g., one or more of a plurality of word lines (e.g., WL0-WLm)) or the data lines (e.g., one or more of a plurality of bit lines (BL0-BLn).

The memory device can include sense circuitry, such as sense amplifiers 108, configured to determine the values of data on (e.g., read), or to determine the values of data to be written to, the memory cells using the data lines. In one example, sense amplifiers are used to sense voltage (e.g., in the case of charge sharing in DRAM). In one example, in selected memory cells, one or more of the sense amplifiers can read a logic level in the selected memory cell in response to a read current flowing in the memory array through the selected cell(s) to the data line(s).

One or more devices external to the memory device can communicate with the memory device using I/O lines (e.g., DQ0-DQN), address lines (e.g., A0-AX), or control lines. I/O circuitry (e.g., 114) can transfer values of data in or out of the memory device, such as in or out of the page buffer or the memory array, using the I/O lines, according to, for example, the control lines and address lines. The page buffer can store data received from the one or more devices external to the memory device before the data is programmed into relevant portions of the memory array, or can store data read from the memory array before the data is transmitted to the one or more devices external to the memory device.

The column decoder 340 can receive and decode address signals (e.g., A0-AX) into one or more column select signals (e.g., CSEL1-CSELn). The selector (e.g., a select circuit) can receive the column select signals (CSEL1-CSELn) and select data in the page buffer representing values of data to be read from or to be programmed into memory cells. Selected data can be transferred between the page buffer and the I/O circuitry.

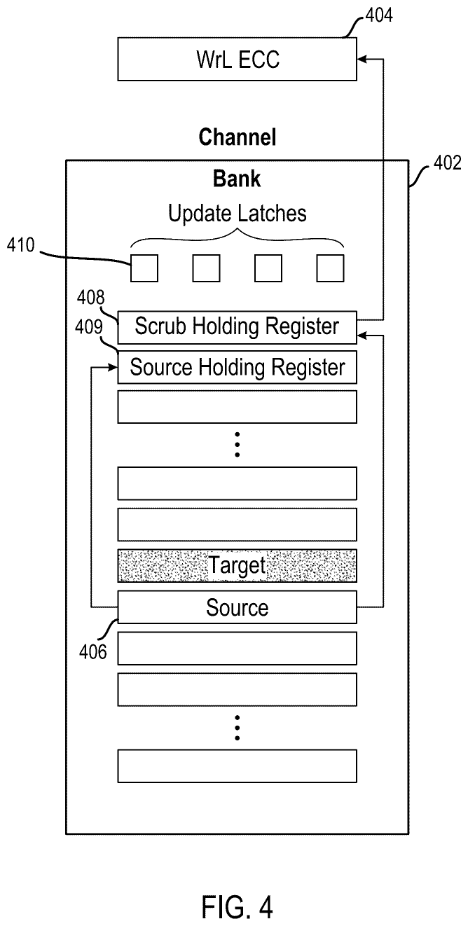

FIG. 4 shows a bank 402 of a memory array having a source holding register 409 and a scrub holding register 408, in accordance with some embodiments. ECC engine 404 services bank 402 during scrub operations. ECC engine 404 is coupled to bank 402 by a scrub loop. Bank 402 is an example of a bank in memory array 106. ECC engine 404 is an example of error correction circuitry 112. In one example, ECC engine 404 is connected to bank 402 using scrub loop 118.

Scrub and source holding registers 408, 409 are an example of temporary storage 120. In response to a first memory management command received by a controller, data is copied from source page 406 to scrub holding register 408 and also to source holding register 409. Code words are sent from scrub holding register 408 to ECC engine 404 for scrubbing.

In one example, a first memory management command is received. In response, source data is moved to the source holding register and the scrub holding register. Update latches are reset LOW. Multiplexing of source data in scrub holding register to ECC engine via a scrub loop is started. This process continues in the background after the first memory management command has been received.

After the first memory management command (e.g., RFM) is received, data is read and written from the source holding register, as described above. After logical to physical address translation is done for a memory access, if the physical address points to the current source row corresponding to source page 406, the source holding register is referenced.

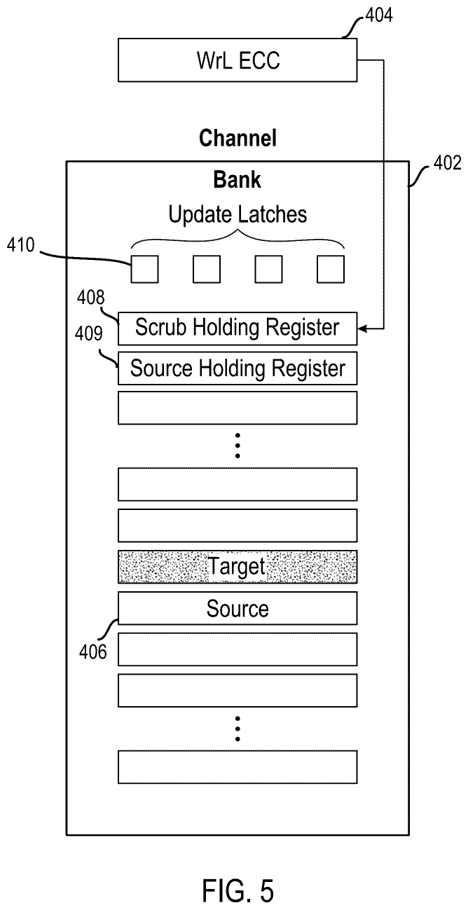

FIG. 5 shows the bank 402 of FIG. 4 during scrub operations using ECC engine 404, in accordance with some embodiments. Code words from scrub holding register 408 are scrubbed by ECC engine 404 in the background while read and write operations are occurring in the same bank. Scrubbed code words are returned to scrub holding register 408.

In one embodiment, one code word at a time is sent to ECC engine 404 using a scrub loop. The scrub loop is shared with multiple banks 402 that are in the same memory management group.

While code words from scrub holding register 408 are being scrubbed, writes can occur to various pages in bank 402. In the case of a write operation that occurs to an address in the source page 406, instead of changing the state of memory cells storing data for source page 406, the data to be written is stored in source holding register 409. Update latches 410 each correspond to one of the code words of source page 406. The state of each latch 410 is changed to indicate whether a particular corresponding code word has been written to source holding register 409.

For example, after receiving the first memory management command, but before receiving the second memory management command (between the first and second memory management commands), if a write command occurs to a column, the respective update latch for that column is set HIGH.

At some time after the first memory management command is received, scrubbed source data arrives to the bank and is loaded into the scrub holding register. Data is still read and written from the source holding register while updating the update latches appropriately.

The second memory management command occurs after scrubbed source data has been loaded into the scrub holding register. In one example, memory management command timing (e.g., tMM2MM specification) is set to ensure that memory management commands are appropriately and sufficiently spaced so that scrubbing has been completed.

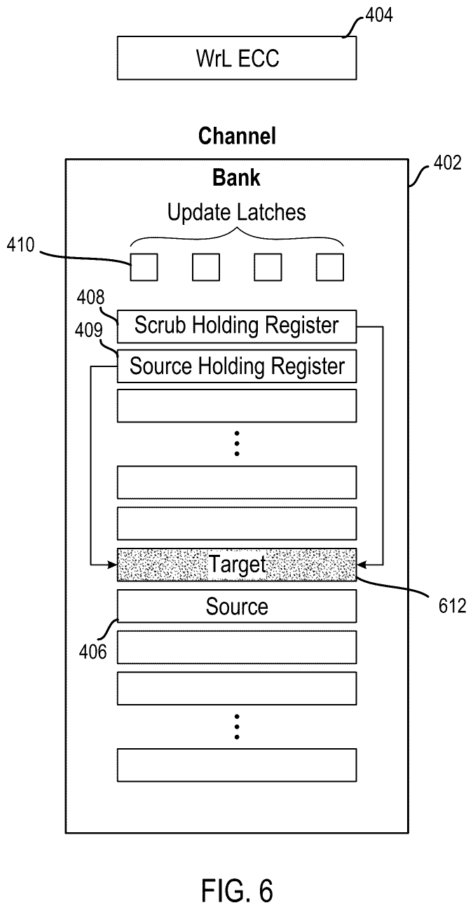

FIG. 6 shows the transfer of scrubbed data to a target page 612 in the bank 402 of FIG. 4, in accordance with some embodiments. After scrubbing of data in the scrub holding register 408 is complete, a controller receives a second memory management command. In response to receiving the second memory management command, scrubbed data from the scrub holding register 408 and source holding register 409 are combined and transferred to target page 612. The data is combined in a way as determined by status data 130. In one example, status data 130 is provided by the states of the update latches 410.

In one example, in response to receiving a second memory management command, for each column (code word):
If update latch is HIGH (a WRITE to column has occurred since the first RFM command), move data in source holding register to target row.
Else if update latch is LOW (no WRITE to column has occurred since first RFM command), move scrubbed source data from scrub holding register to target row.

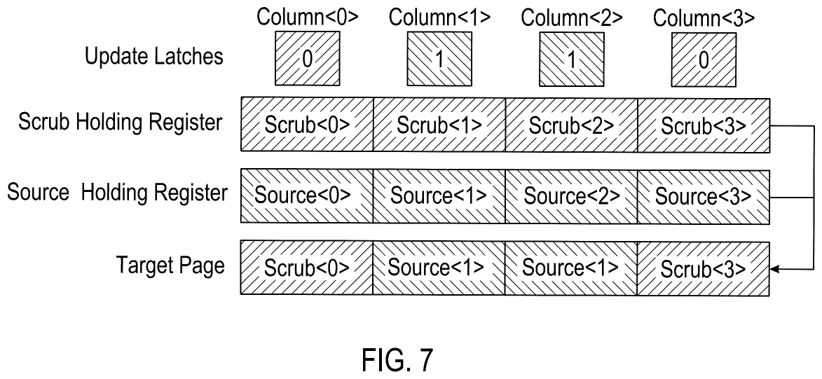

FIG. 7 shows a non-limiting example of the transfer of scrubbed data to a target page (e.g., 612 of FIG. 6) using update latches (e.g., 410), in accordance with some embodiments. The update latches are set either low or high, as indicated by 0 or 1. This is done for each column of the target page. Each column corresponds to a code word of the target page. If an update latch is set low for a code word, then data for that code word is copied from the scrub holding register to the target page. If an update latch is set high for a code word, then that code word is copied from the source holding register to the target page. If the update latch is set high for a code word, that is an indication that the corresponding code word was written to during the scrubbing of the code word by the ECC engine. Thus, the scrub and source holding registers through combination form the target page according the state of the update latches.

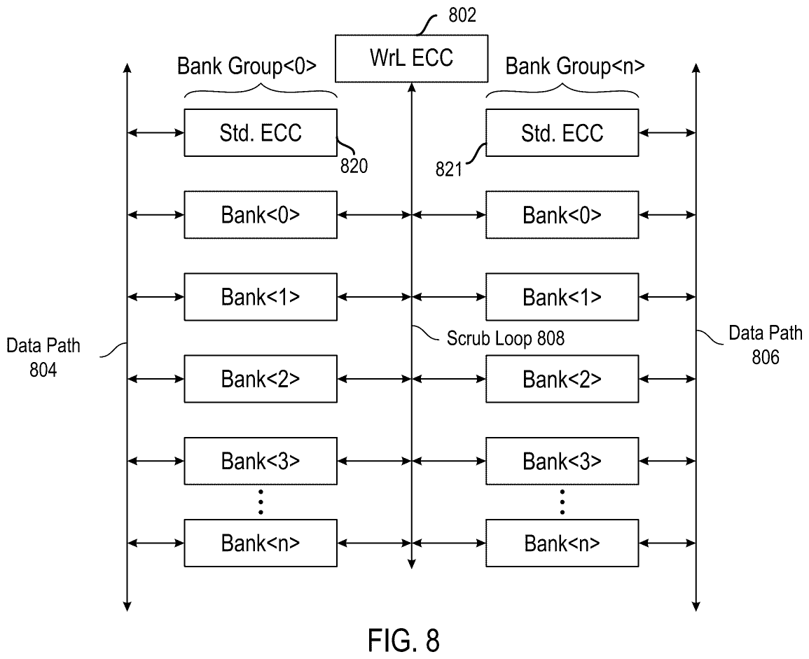

FIG. 8 shows a data path 804, 806 for read and write operations for a host device (e.g., 101) and a scrub loop 808 shared by multiple banks for servicing scrubbing operations, in accordance with some embodiments. ECC engine 802 scrubs data sent from various banks using scrub loop 808. The banks can be arranged in bank groups. The ECC engine 802 can service one or both bank groups for any given operation or time interval.

It should be noted that, in general, any number of banks or bank groups may be serviced by the WrL ECC engine. For example, all banks of the memory device could be serviced by a WrL ECC engine. FIG. 8 shows a specific case corresponding to an embodiment in which: each bank group can share it's own standard ECC engine, and a WrL ECC engine is shared amongst any number “n” of bank groups (indicated by “Bank Group <n>”).

In some embodiments, to reduce total scrub time (thereby reducing tMM2MM), there may be multiple WrL ECC engines that exist on the memory device to allow multiple banks to be scrubbed in parallel. For example, a memory device may contain four bank groups, four standard (Std.) ECC engines, and two WrL ECC engines. In this case, each bank group is associated with it's own standard ECC engine, and a set of two bank groups is associated with it's own WrL ECC engine. A memory management group may contain subset of banks that may exist across one or more bank groups.

In general, a greater number of WrL ECC engines results in reduced scrub time (related to tMM2MM). Reduced scrub time is associated with reduced system impact and command scheduling issues. However, a greater number of WrL ECC engines result in additional die size. Thus, there is a trade off between scrub time and die size.

Scrub loop 808 is an example of scrub loop 118. ECC engine 802 is an example of error correction circuitry 112. Data path 804, 806 is an example of a data path including I/O circuitry 114 and communication interface 116.

In one embodiment, each bank group has an associated standard ECC engine 820, 821. ECC engines 820, 821 service read and write operations on data paths 804, 806. ECC engines 820, 821 are an example of error correction circuitry 110.

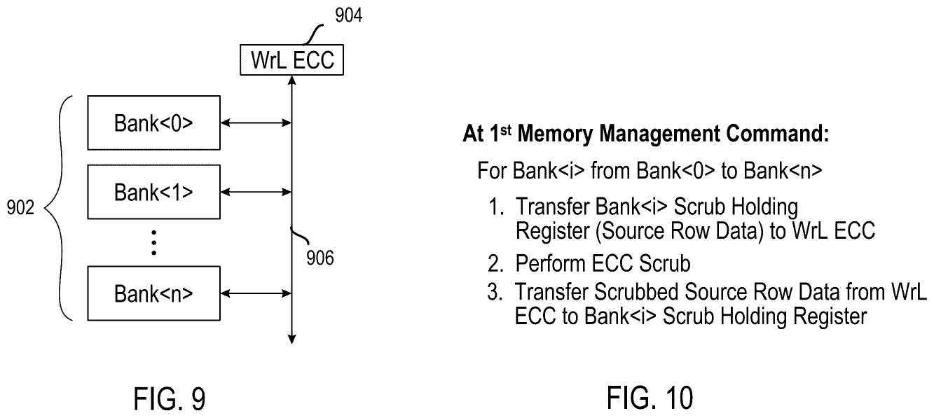

FIG. 9 shows banks of a memory management group 902 coupled to a wear leveling ECC engine 904, in accordance with some embodiments. Portions of data from each bank are sent to ECC engine 904 for scrubbing using scrub loop 906. Scrub loop 906 is a separate data path from the data path used for read and write operations, such as described above.

It should be noted that the embodiment depicted by FIG. 9 is a first case that assumes each memory management group is associated with it's own WrL ECC engine. In this case, multiple memory management commands (to different memory management groups) could occur in parallel. However, the appropriate tMM2MM value must elapse until a memory management command occurs to the same management group.

However, in some embodiments for a second case, a WrL ECC engine may be associated with a plurality of memory management groups. In this case, the tMM2MM (for a set of memory management groups) value may be increased. In this case, a memory management command could not be issued to a set of memory management groups that share the same WrL ECC engine until the appropriate tMM2MM value elapses.

In a third case, in some embodiments, a WrL ECC engine may be associated with a subset of a memory management group (e.g., half of the banks associated with a memory management group). In this case, the scrub operation may occur for subsets of the memory management group in parallel to reduce the scrub time and thereby reduce the tMM2MM (for the same memory management group) specification. Also, in this case, multiple memory management commands (to different memory management groups) could occur in parallel like the case in which each memory management group is associated with one WrL ECC engine (as described for the first case above).

FIG. 10 shows a process for scrubbing multiple banks in a memory management group, in accordance with some embodiments. In one example, the banks are in memory management group 902. When a first memory management command is received, such as described above, then source read data for each bank is transferred from a scrub holding register to ECC engine 904. After the scrub is performed, the scrubbed source row data is transferred from ECC engine 904 back to the scrub holding register.

It should be noted that FIG. 10 corresponds to the first and second cases described above for FIG. 9. However, for the third case for FIG. 9 above, a plurality of the illustrated “for loops” can be running in parallel. In this case, each “for loop” scrubs a unique subset (of banks) of the memory management group.

In one embodiment, use of a separate wear leveling ECC engine as described herein frees up the main data bus so that reads and writes can occur to other banks during the maintenance mode cycle. The standard ECC engine is always available to handle reads and writes. It does not handle the scrubbing.

In one example, there is an update latch for each code word that exists in a page. There can be any number of pages in the wear leveling pool. The scrub and source holding registers, and update latches are shared by all pages in the pool.

In one embodiment, the standard data bus used for read and write operations is wider than the database used for the scrub loop. This is done so that reads and writes can occur quickly. The data bus from the scrub holding register to the ECC engine is narrower than the standard data bus (scrub loop is the narrower data path). After the scrub of each code word, it is returned to the scrub holding register. This occurs in the background for all the banks in a memory management group.

In one embodiment, data can be accessed within the wear leveling pool through activates (e.g., a controller can read and write that data). In one example, if the source page is activated, the controller activates the source holding register instead of the source page being activated in the array. For example, a logical address is issued to a particular bank, and the corresponding physical address points to the source row. So, the source holding register is activated.

In one embodiment, in the background between the first and second memory management commands, data is being scrubbed and then sent back to the scrub holding register. A read or write can occur during this time to the source page, which is redirected to the source holding register. If there is a read, the data is sent on the standard data bus up to the ECC engine at the bank group edge. If there is a write, parity is generated for the incoming data by the ECC engine. For that particular code word in the source holding register, the data and parity are written into the source holding register. Note that the scrub holding register data is not updated by the write commands.

For example, if code word 0 is written, then the update latch for code word 0 is set high. If the update latch is high, that means the particular code word was written to while the scrub was occurring. The memory specification is set to allow enough time for all banks to be scrubbed using the narrower bus of the scrub loop before the second memory management command is received.

At the second memory management command, data is moved for columns that have been changed by a write as indicated by the update latches. The target row is thus a combination of the data in the scrub holding register and the source holding register as governed by the update latches.

In one example, each page of a bank consists of code words or columns. The second memory management command has been issued to a particular bank. The page is the set of specific memory cells that are activated when an activate command is issued. An activate command has a bank address as well as a row address.

In one embodiment, each bank group is coupled to a particular data path for that bank group. One or more bank groups are associated with a wear leveling ECC engine. The scrub loop is typically a smaller data path to minimize die area. In one example, a narrower data path transfers a smaller number of bits in a given time than the standard data path. In one example, a standard data path is 100 bits wide and a scrub loop is 10 bits wide.

In one example, a particular memory die may have many memory management groups. A memory management command is issued to a specific memory management group. This causes a memory management operation to occur for all banks in the group. The group is coupled to the wear level ECC engine. A controller iterates through each bank in the group.

In one embodiment, a DRAM device uses an error check and scrub (ECS) mode. On a periodic basis, a controller grabs data from a certain row in the array, scrubs the data with an ECC engine, and then puts the data back to that row. A main ECC engine is shared among multiple banks for reads and writes. A separate ECC engine with a scrub loop is used to permit performing the ECS scrub on a different bank from a bank being read or written at the same time.

In one embodiment, the standard data bus for a memory device is a bi-directional bus. The scrub loop of the memory device is either a bi-directional or uni-directional bus.

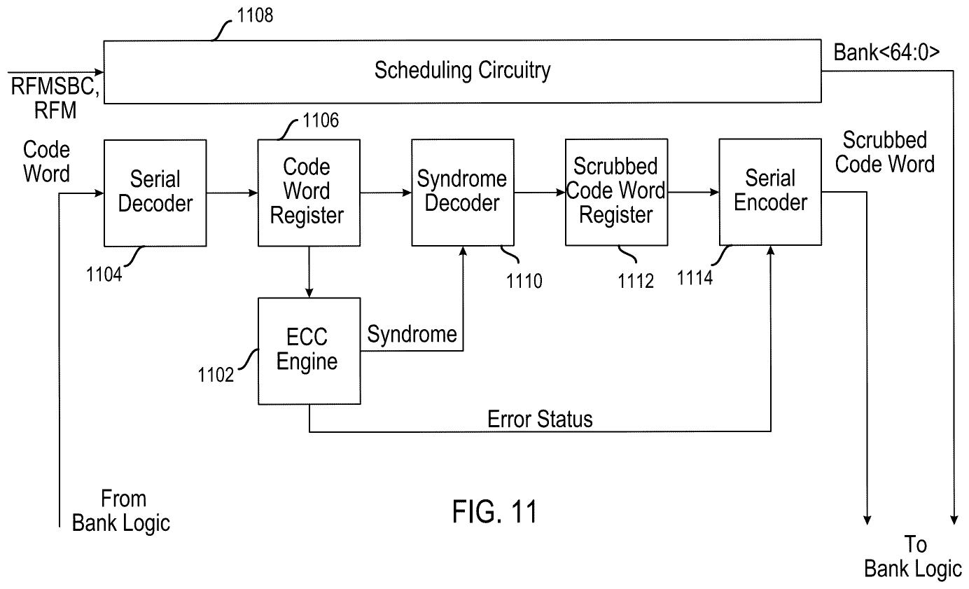

FIG. 11 shows error correction circuitry (e.g., error correction circuitry 112) for scrubbing code words from a bank of a memory array, in accordance with some embodiments. In one example, the code words are received from bank 402.

Scheduling circuitry 1108 receives signals from a controller. One of the signals is a first memory management command (e.g., RFM). Another signal is a signal that indicates a grouping of banks and/or bank groups to use for memory management operations. Another signal is a signal provided from a mode register setting that sets the granularity of the memory management group or bank size (e.g., RFMSBC). Scheduling circuitry 1108 sends signals to logic circuitry of one or more banks to control transfer of code words from each bank to serial decoder 1104.

In one example, eight banks are run in parallel for wear leveling. The scrub time of one bank is proportional to the bus width of the wear leveling ECC engine that services the bank.

In one embodiment, serial decoder 1104 receives one code word at a time from each bank. The code word is decoded by serial decoder 1104 and stored in code word register 1106. ECC engine 1102 generates a syndrome for the code word as an output. The syndrome is decoded by syndrome decoder 1110, and a scrubbed code word is provided as output and stored in register 1112. The scrubbed code word is encoded by serial encoder 1114 and transferred back to the bank that sent the code word.

When performing error detection and/or correction on each code word, ECC engine 1102 generates various signals (illustrated as “Error Status”) indicating a state or status from processing the code word. In one embodiment, the signal is an uncorrectable error alert that indicates the code word contains one or more uncorrectable errors. One or more of these signals are provided to serial encoder 1114, which encodes the signals for sending to the bank to which the code word is returned. The signal can be used by a controller to modify operations of the memory device.

In one embodiment, transmission of the scrubbed code word to the bank logic and transmission of the next code word from the bank logic may occur simultaneously.

In one embodiment, the memory device is nonvolatile, but the holding registers are volatile (e.g., CMOS) registers. If power is lost while scrub is occurring in the background, data can be lost if not already transferred to the target row. The write data might be in the volatile source holding register. In one example, if power is detected as being lost, a controller uses available capacitance to transfer the data.

In one embodiment, bank logic or a controller performs a wear leveling soft repair based on a signal from the wear leveling ECC engine. This mitigates the risk of the accumulation of uncorrectable errors throughout the entire array.

An uncorrectable physical defect (e.g., 4 or 5 bits stuck low), can not be corrected because the number of errors exceed the correction capabilities of the WrL ECC engine. Thus, in the event of an uncorrectable error, the WrL ECC engine detects that there is an uncorrectable error, but does not attempt to correct the data. In this case, the data remains unchanged with the uncorrectable error still existing in the scrub holding register.

For example, if there is a source page that is uncorrectable (e.g., 4 or 5 bits stuck high or low), because all data in a wear leveling pool ultimately moves through any given page, it could eventually corrupt all data in the wear leveling pool. To reduce this risk, a wear level soft repair occurs.

Scrubbing correctable errors during wear leveling prevents the accumulation correctable errors that could aggregate into an uncorrectable error (e.g., as described above). However, a wear leveling soft repair can be used to mitigate the risk of an uncorrectable defect corrupting the entire wear leveling pool (e.g., as described below).

In one example, the wear leveling ECC engine detects that there is an uncorrectable error. The ECC engine can identify that there is uncorrectable data in the source row. Within the memory management cycle, the ECC engine automatically performs a soft repair. Wear leveling movement cycles are moved away from the defective source row. The wear leveling ECC engine sends an indication of an uncorrectable error back to the bank logic and an automatic soft repair can be done to the source row. This allows wear leveling movements to be diverted from the physically bad row.

In one embodiment, the wear leveling ECC circuitry uses two uni-directional buses for connecting to the appropriate banks. Code words are transmitted on a data bus and this information is decoded using the serial decoder. A code word register is populated. The wear leveling ECC engine computes parity and compares the computed parity to the stored parity to produce a syndrome. A syndrome decode occurs which may cause some bits to flip to correct the code word.

The error status signal(s) generated by ECC engine 1102 may consist, for example, of the following cases for which data can be communicated to the bank logic:
[Case 1] No errors
[Case 2] Error detected and corrected
[Case 3] Two errors detected and corrected
[Case 4] Uncorrectable error

It should be noted that this pattern can be reduced or extended to cover an ECC engine of any error detection and correction capability.

For the case of an uncorrectable error (e.g., case 4), the ECC engine is unable to provide any correction. Thus, the uncorrectable error cannot be corrected (e.g., scrubbed). In this case, the ECC engine may decide to send the same data it received back to the bank logic. Alternatively, the ECC engine may not send any data to the bank logic due to the scrub register requiring no update. Whether or not the ECC engine sends the uncorrected data back to the bank logic, the ECC engine may send the error status back to the bank logic.

When the bank logic receives the error status, some action may occur. For example, a wear leveling soft repair may occur. In some embodiments, a wear leveling soft repair may occur when a certain number of errors are detected. The exact number of errors (e.g., case 2, case 3, or case 4) is dependent upon process/yield capability.

In one embodiment, a pair of two holding registers are used. In this case, a wear leveling page consists of two pages. There would be two source pages and two target pages. The scrub holding register would be doubled in size compared to the description above.

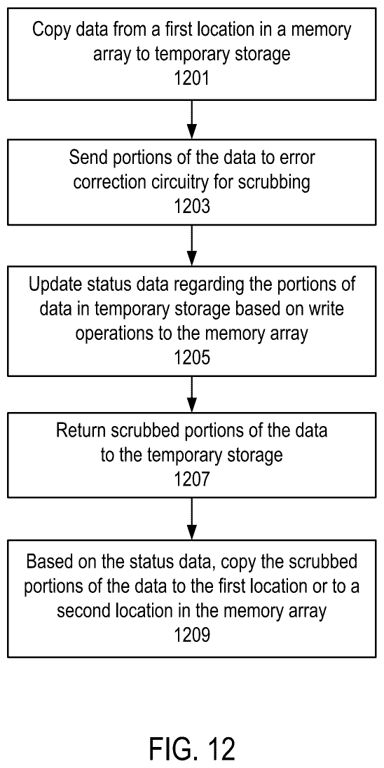

FIG. 12 shows a method for scrubbing data in a memory array using temporary storage, in accordance with some embodiments. For example, the method of FIG. 12 can be implemented in the memory device 102 of FIG. 1. In one example, data from a source page in the memory array 106 is moved to temporary storage 120. The moved data is transmitted to error correction circuitry 112 using scrub loop 118. Writes that occur to the address of the source page during scrubbing are recorded as status data 130. After scrubbing is complete, the scrubbed data is moved to a target page in memory array 106. The scrubbed data moved to the target page is determined based on any writes that occurred as indicated by status data 130.

The method of FIG. 12 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method of FIG. 12 is performed at least in part by one or more processing devices (e.g., controller 104 of FIG. 1) and/or by logic circuitry.

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 1201, data is copied from a first location in a memory array to temporary storage. In one example, the temporary storage is scrub and source holding registers 408, 409.

At block 1203, portions of the data are sent to error correction circuitry for scrubbing. In one example, the error correction circuitry is ECC engine 404.

At block 1205, status data is updated regarding the portions of data and temporary storage based on write operations to the memory array. In one example, update latches 410 are set to indicate write operations that occur to the source page during scrubbing.

At block 1207, scrubbed portions of the data are returned to the temporary storage from the error correction circuitry. In one example, scrubbed code words are returned to scrub holding register 408.

At block 1209, the scrubbed portions of the data are copied to the first location based on the status data. For example, data stored in a DRAM is scrubbed and returned to the same address location. In an alternative embodiment, the scrubbed portions of the data are copied to a second location in the memory array. For example, data from a source page is scrubbed and then copied to a target page. In one example, scrubbed code words are copied to target page 612 based on the states of update latches 410 (e.g., data is combined as illustrated in FIG. 7).

In some aspects, the techniques described herein relate to an apparatus including: a first register (e.g., a scrub holding register); a second register (e.g., a source holding register); and at least one controller configured to: move data from a source page to the first and second registers; update the data in the first register based on error correction of the data; and update the data in the second register based on a write that occurs to the source page.

In some aspects, the techniques described herein relate to an apparatus, further including error correction circuitry (e.g., wear-leveling ECC engine), wherein the error correction is performed by the error correction circuitry.

In some aspects, the techniques described herein relate to an apparatus, wherein the write occurs during the error correction.

In some aspects, the techniques described herein relate to an apparatus, wherein the controller is further configured to move data to a target page based on a combination of data from the first and second registers.

In some aspects, the techniques described herein relate to an apparatus, further including a plurality of latches configured to indicate writes that occur to the source page, wherein the combination of data is based on indications by the latches.

In some aspects, the techniques described herein relate to an apparatus, further including a plurality of latches configured to indicate writes that occur to the source page, wherein each latch corresponds to a code word in the source page, and each latch is configured to indicate whether the respective code word has been written.

In some aspects, the techniques described herein relate to an apparatus, further including a first data path used in read and write operations for a plurality of banks, and a second data path (e.g., scrub loop) configured to connect the first register to error correction circuitry (e.g., WIL ECC engine), wherein a bandwidth of the second data path is less than a bandwidth of the first data path.

In some aspects, the techniques described herein relate to an apparatus, wherein: the source page is in a wear-leveling pool; the apparatus further includes error correction circuitry configured to provide a signal (e.g., uncorrectable error alert or other error status signal); and movement of data in the wear-leveling pool is modified based on the signal.

In some aspects, the techniques described herein relate to an apparatus, wherein: the source page is in a wear-leveling pool; and the apparatus further includes first error correction circuitry configured to service read and write operations in response to commands from a host device, and second error correction circuitry configured to service scrub operations during wear-leveling for the pool.

In some aspects, the techniques described herein relate to an apparatus, wherein the controller is further configured to transfer code words from the first register to an error correction code (ECC) engine for scrubbing, and transfer scrubbed code words from the ECC engine to the first register.

In some aspects, the techniques described herein relate to an apparatus including: at least one memory array (e.g., 106); and at least one controller (e.g., 104) configured to: perform read and write operations for first data in the memory array using error correction; and scrub second data in the memory array during the read and write operations.

In some aspects, the techniques described herein relate to an apparatus, wherein the read and write operations use first error correction circuitry (e.g., main ECC engine, error correction circuitry 110), and the scrubbing uses second error correction circuitry (e.g., error correction circuitry 112 including a separate ECC engine connected to memory banks using a scrub loop 118).

In some aspects, the techniques described herein relate to an apparatus, wherein the memory array is configured in a volatile memory device (e.g., DRAM), and the second data is scrubbed as part of an error check and scrub (ECS) operation.

In some aspects, the techniques described herein relate to an apparatus, wherein the controller is configured to: determine that the first data is targeted for writing to a first page, and the second data is stored in the first page when the scrubbing is performed; temporarily store the first data (e.g., store in one or more registers or buffers); and after the scrubbing is complete, move the first data to the first page or a second page in the memory array.

In some aspects, the techniques described herein relate to an apparatus, further including a plurality of latches (e.g., update latches 410) configured to store indications associated with writing at least one code word of the first data, wherein the first data is stored in memory cells of the first or second page based on the indications.

In some aspects, the techniques described herein relate to an apparatus, wherein the controller is further configured to transfer the scrubbed second data to a target page except that those code words of the second data that are written to during the scrubbing are not transferred to the target page (e.g., data is stored in the target page by copying code words from a temporary buffer used during scrubbing except for those code words written to during the scrub).

In some aspects, the techniques described herein relate to an apparatus, wherein the second data is scrubbed using error correction circuitry coupled to receive the second data as code words from a bank of the memory array using a first bus (e.g., a bus of scrub loop 118) that is separate from a second bus used to transfer the first data for the read and write operations (e.g., a bus of a data path used for read and write operations performed for host device 101).

In some aspects, the techniques described herein relate to a method including: scrubbing data for a source page of a memory array; and performing an operation to write data to the source page during the scrubbing.

In some aspects, the techniques described herein relate to a method, wherein the data being written is stored at a temporary storage location (e.g., register or buffer) during the scrubbing (e.g., source holding register).

In some aspects, the techniques described herein relate to a method, wherein data is written from the temporary storage location to a target page after the data is scrubbed (e.g., scrubbed data is stored in the scrub holding register, and the data is written using a combination of code words from the scrub holding register and the source holding register).

In one embodiment, a method of sharing an ECC engine across multiple wear leveling pools is used for the purpose of facilitating ECC scrubs during wear leveling within a memory device. A set of two holding registers is used per wear leveling pool.

In other embodiments, two or more sets of holding registers can be used. For example, a memory bank can have a pair of two source/scrub holding registers and manage wear leveling ECC to correct two pages before downloading back into two targets.

In one embodiment, the first holding register is used in place of the source row in between two memory management commands during which time reads and writes are directed to the first holding register. The second holding register stores the contents of the source row for transmission to the shared ECC engine and stores scrubbed source row data received from the shared ECC engine.

A number of update latches equivalent to the number of code words within a page of a wear leveling pool is used. The latches are used so that the target row is composed of a combination of code words from the set of two holding registers where the specific combination is dependent upon the state of update latches.

In some examples, data transfer may occur simultaneously from a wear leveling pool to the shared ECC engine and from the ECC engine to a wear leveling pool.

In some examples, the memory device may be non-volatile in which case the ECC scrub operations must complete, and data be transferred to a target row automatically upon a power removal event (e.g., unexpected power loss).

In some examples, in addition to transmitting scrubbed source data to the bank, the wear leveling ECC engine may also send additional information concerning any possible errors (e.g., no error, single-bit error, multiple-bit error, or uncorrectable error) to the controller and/or to logic circuitry of the bank. Based upon the reception of this information, the bank may determine to perform an action such as performing an automatic repair to the source row in the background.

In one example, memory device operation includes issuance of various commands. Non-limiting details regarding certain exemplary commands are provided below:
Memory device operation
   When activate to row address x is issued.
      The row address x may be addressed by addressing bits on the activate command in the following manner
         Bank address (to specify which bank within the memory device).
         Row address (to specify which row within the specified bank)
      Word line associated with row address x brought high
      Sense page which causes data to reside in sense amp latches
   When a read command for column y of activated row address x is issued (read command must occur while a row is activated)
      Summary: read corrected data of the data that resides in the sense amplifier (SA) latches associated with column y.
      Note: read command contains the following addressing bits
         Bank address (to specify which bank within the memory device)
         Column address (to specify which column of the activated row within the specified bank)
      Full details:
         Note: Column y data is represented by the state of the SA latches associated with column y
         Furthermore, column y is associated with a code word which consists of data bits and parity bits
         Data and parity from SA latches of the appropriate column fed through Code Word ECC Engine
         Error detection
         Syndrome generated based upon computed (parity calculated from data residing in “data” SA latches) and stored parity (parity stored directly in SA latches).
         Any correctable errors are corrected “SA latch data remains unchanged
         Data output is corrected.
         Possibly corrected data sent out of memory device on DQs (IO pins) of memory device
   When a write command for column y of activated row address x is issued (write command must occur while a row is activated)”
      Summary: alter SA latches associated with column y to contain new write data and associated parity.
      Note: write command contains the following addressing bits
         Bank address (to specify which bank within the memory device)
         Column address (to specify which column of the activated row within the specified bank)
      Full details.
         Data input from DQs (IO pins) of memory device
         Data fed through Code Word ECC Engine
         Parity generated based upon input data
         Input data and generated parity (code word) written into the SA latches of the appropriate column
   When precharge command is issued
      Summary: A precharge command will result in an implicit write to the cells and then the word line is brought low.
         The cells will now contain the data (all the data and all the parity of all the code words) residing with the SA latches.
      Note: precharge command contains the following addressing bits
         Bank address (whatever row is activated in the bank is precharged)
      Full details:
         Write page data into memory cells
         Data residing within all SA latches written to memory cells
      Word line associated with row address x brought low after data is written into the memory cells

A non-limiting example of a memory device is now described.
Various details regarding use of a code word ECC engine are presented below:
   Various details are provided below as to the operation and behavior of the memory device:
      Memory array behavior
         On activate commands (ACTs): Sense page of memory array which causes data to reside in sense amplifier (or simply “sense amp”) latches
         On precharge commands (PREs): Write data in sense amp latches into page of memory array
      Code Word ECC Engine behavior
         On Writes
         Data input from DQs (IO pins) of memory device
         Data fed through Code Word ECC Engine
         Parity generated based upon input data
         Input data and generated parity (code word) written into the sense amplifier (SA) latches of the appropriate column
         On Reads
         Data from SA latches of the appropriate column fed through Code Word ECC Engine
         Syndrome generated based upon computed and stored parity (error detection)
         Any correctable errors are corrected
         SA latch data remains unchanged
         Data output is corrected
         Possibly corrected data sent out of memory device on DQs

The disclosure includes various devices which perform the methods and implement the systems described above, including data processing systems which perform these methods, and computer-readable media containing instructions which when executed on data processing systems cause the systems to perform these methods.

The description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In this description, various functions and/or operations may be described as being performed by or caused by software code to simplify description. However, those skilled in the art will recognize what is meant by such expressions is that the functions and/or operations result from execution of the code by one or more processing devices, such as a microprocessor, Application-Specific Integrated Circuit (ASIC), graphics processor, and/or a Field-Programmable Gate Array (FPGA). Alternatively, or in combination, the functions and operations can be implemented using special purpose circuitry (e.g., logic circuitry), with or without software instructions. Embodiments can be implemented using hardwired circuitry without software instructions, or in combination with software instructions. Thus, the techniques are not limited to any specific combination of hardware circuitry and software, nor to any particular source for the instructions executed by a computing device.

While some embodiments can be implemented in fully functioning computers and computer systems, various embodiments are capable of being distributed as a computing product in a variety of forms and are capable of being applied regardless of the particular type of computer-readable medium used to actually effect the distribution.

At least some aspects disclosed can be embodied, at least in part, in software. That is, the techniques may be carried out in a computing device or other system in response to its processing device, such as a microprocessor, executing sequences of instructions contained in a memory, such as ROM, volatile RAM, non-volatile memory, cache or a remote storage device.

Routines executed to implement the embodiments may be implemented as part of an operating system, middleware, service delivery platform, SDK (Software Development Kit) component, web services, or other specific application, component, program, object, module or sequence of instructions (sometimes referred to as computer programs). Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A computer-readable medium can be used to store software and data which when executed by a computing device causes the device to perform various methods. The executable software and data may be stored in various places including, for example, ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a computer-readable medium in entirety at a particular instance of time.

Examples of computer-readable media include, but are not limited to, recordable and non-recordable type media such as volatile and non-volatile memory devices, read only memory (ROM), random access memory (RAM), flash memory devices, solid-state drive storage media, removable disks, magnetic disk storage media, optical storage media (e.g., Compact Disk Read-Only Memory (CD ROMs), Digital Versatile Disks (DVDs), etc.), among others. The computer-readable media may store the instructions. Other examples of computer-readable media include, but are not limited to, non-volatile embedded devices using NOR flash or NAND flash architectures. Media used in these architectures may include un-managed NAND devices and/or managed NAND devices, including, for example, eMMC, SD, CF, UFS, and SSD.

In general, a non-transitory computer-readable medium includes any mechanism that provides (e.g., stores) information in a form accessible by a computing device (e.g., a computer, mobile device, network device, personal digital assistant, manufacturing tool having a controller, any device with a set of one or more processors, etc.). A “computer-readable medium” as used herein may include a single medium or multiple media (e.g., that store one or more sets of instructions).

In various embodiments, hardwired circuitry may be used in combination with software and firmware instructions to implement the techniques. Thus, the techniques are neither limited to any specific combination of hardware circuitry and software nor to any particular source for the instructions executed by a computing device.

Various embodiments set forth herein can be implemented using a wide variety of different types of computing devices. As used herein, examples of a “computing device” include, but are not limited to, a server, a centralized computing platform, a system of multiple computing processors and/or components, a mobile device, a user terminal, a vehicle, a personal communications device, a wearable digital device, an electronic kiosk, a general purpose computer, an electronic document reader, a tablet, a laptop computer, a smartphone, a digital camera, a residential domestic appliance, a television, or a digital music player. Additional examples of computing devices include devices that are part of what is called “the internet of things” (IoT). Such “things” may have occasional interactions with their owners or administrators, who may monitor the things or modify settings on these things. In some cases, such owners or administrators play the role of users with respect to the “thing” devices. In some examples, the primary mobile device (e.g., an Apple iPhone) of a user may be an administrator server with respect to a paired “thing” device that is worn by the user (e.g., an Apple watch).

In some embodiments, the computing device can be a computer or host system, which is implemented, for example, as a desktop computer, laptop computer, network server, mobile device, or other computing device that includes a memory and a processing device. The host system can include or be coupled to a memory sub-system so that the host system can read data from or write data to the memory sub-system. The host system can be coupled to the memory sub-system via a physical host interface. In general, the host system can access multiple memory sub-systems via a same communication connection, multiple separate communication connections, and/or a combination of communication connections.

In some embodiments, the computing device is a system including one or more processing devices. Examples of the processing device can include a microcontroller, a central processing unit (CPU), special purpose logic circuitry (e.g., a field programmable gate array (FPGA), an application specific integrated circuit (ASIC), etc.), a system on a chip (SoC), or another suitable processor.

In one example, a computing device is a controller of a memory system. The controller includes a processing device and memory containing instructions executed by the processing device to control various operations of the memory system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

1. An apparatus comprising:
a first register;
a second register; and
at least one controller configured to:
move data from a source page to the first and second registers;
update the data in the first register based on error correction of the data; and
update the data in the second register based on a write that occurs to the source page.

2. The apparatus of claim 1, further comprising error correction circuitry, wherein the error correction is performed by the error correction circuitry.

3. The apparatus of claim 1, wherein the write occurs during the error correction.

4. The apparatus of claim 1, wherein the controller is further configured to move data to a target page based on a combination of data from the first and second registers.

5. The apparatus of claim 4, further comprising a plurality of latches configured to indicate writes that occur to the source page, wherein the combination of data is based on indications by the latches.

6. The apparatus of claim 1, further comprising a plurality of latches configured to indicate writes that occur to the source page, wherein each latch corresponds to a code word in the source page, and each latch is configured to indicate whether the respective code word has been written.

7. The apparatus of claim 1, further comprising a first data path used in read and write operations for a plurality of banks, and a second data path configured to connect the first register to error correction circuitry, wherein a bandwidth of the second data path is less than a bandwidth of the first data path.

8. The apparatus of claim 1, wherein:
the source page is in a wear-leveling pool;
the apparatus further comprises error correction circuitry configured to provide a signal; and
movement of data in the wear-leveling pool is modified based on the signal.

9. The apparatus of claim 1, wherein:
the source page is in a wear-leveling pool; and
the apparatus further comprises first error correction circuitry configured to service read and write operations in response to commands from a host device, and second error correction circuitry configured to service scrub operations during wear-leveling for the pool.

10. The apparatus of claim 1, wherein the controller is further configured to transfer code words from the first register to an error correction code (ECC) engine for scrubbing, and transfer scrubbed code words from the ECC engine to the first register.

11. An apparatus comprising:
at least one memory array; and
at least one controller configured to:
perform read and write operations for first data in the memory array using error correction; and
scrub second data in the memory array during the read and write operations.

12. The apparatus of claim 11, wherein the read and write operations use first error correction circuitry, and the scrubbing uses second error correction circuitry.

13. The apparatus of claim 11, wherein the memory array is configured in a volatile memory device, and the second data is scrubbed as part of an error check and scrub (ECS) operation.

14. The apparatus of claim 11, wherein the controller is configured to:
determine that the first data is targeted for writing to a first page, and the second data is stored in the first page when the scrubbing is performed;
temporarily store the first data; and
after the scrubbing is complete, move the first data to the first page or a second page in the memory array.

15. The apparatus of claim 14, further comprising a plurality of latches configured to store indications associated with writing at least one code word of the first data, wherein the first data is stored in memory cells of the first or second page based on the indications.

16. The apparatus of claim 11, wherein the controller is further configured to transfer the scrubbed second data to a target page except that those code words of the second data that are written to during the scrubbing are not transferred to the target page.

17. The apparatus of claim 11, wherein the second data is scrubbed using error correction circuitry coupled to receive the second data as code words from a bank of the memory array using a first bus that is separate from a second bus used to transfer the first data for the read and write operations.

18. A method comprising:
scrubbing data for a source page of a memory array; and
performing an operation to write data to the source page during the scrubbing.

19. The method of claim 18, wherein the data being written is stored at a temporary storage location during the scrubbing.

20. The method of claim 19, wherein data is written from the temporary storage location to a target page after the data is scrubbed.
